(19) United States
(12) Patent Application Publication
(10) Pub. No.: US 2024/0093022 A1
(43) Pub. Date: Mar. 21, 2024

(54) Curable Two-Part Resin System

(71) Applicant: HUNTSMAN ADVANCED MATERIALS LICENSING (SWITZERLAND) GmbH, Basel (CH)

(72) Inventors: Christian BEISELE, Basel (CH); Daniel BAER, Basel (CH); Florian GNAEDINGER, Basel (CH)

(21) Appl. No.: 18/039,549

(22) PCT Filed: Dec. 20, 2021
(86) PCT No.: PCT/EP2021/086916

§ 371 Date: May 31, 2023

(30) Foreign Application Priority Data
Dec. 22, 2020 (EP) 20216430.7

(51) Int. Cl. C08L 63/00; C08K 3/013; C08K 5/09

(52) U.S. Cl. CPC C08L 63/00; C08K 3/013; C08K 5/09; C08K 2201/019

(57) ABSTRACT

The present invention relates to a curable two-part resin system having a resin part containing at least one cycloaliphatic epoxy resin and a hardener part containing (i) at least one alicyclic anhydride, and (ii) a block-copolymer having polysiloxane blocks and organic blocks, and containing greater than 60 wt % of an inorganic filler.

### FIELD

The present disclosure generally relates to a curable two-part resin system, cured articles obtainable therefrom, and uses thereof.

### BACKGROUND

Curable resin systems are widely known for various purposes. One area of interest is the use of such systems for the encapsulation of stators and/or rotors of electrical motors, usually by casting. A number of curable systems are disclosed in the prior art, including:

WO 2016/202608 A1 discloses curable compositions based on cycloaliphatic epoxy resins, which can be used as insulating materials for electrical and electronic components like printed circuit boards. WO 2016/202608 A1 is silent on the use of crystalline inorganic fillers or block-copolymers with polysiloxane blocks and organic blocks. Although WO 2016/202608 A1 discloses a composition containing epoxycyclohexylmethyl epoxycyclohexanecarboxylate and methylnorbornene-2,3-dicarboxylic acid anhydride, it is free of inorganic fillers or block-copolymers with polysiloxane blocks and organic blocks.

WO 2010/112272 A1 discloses a system containing wollastonite and fused silica. However, the system disclosed therein is based on bisphenol A diglycidyl ether (BADGE) rather than a cycloaliphatic epoxy resin and shows a poor performance as compared to the presently disclosed two-part resin system.

EP 3255103 B1 relates to a resin system containing a block-copolymer component but no amorphous or crystalline filler. In particular, the glass transition temperature (“Tg”) of such resin system is low as compared to the presently disclosed two-part resin system.

The BADGE-based resin of WO 2019/175342 A1 comprises a block-copolymer component but lacks an amorphous inorganic filler, resulting in a low crack temperature index (SCT) and a low Tg as compared to the presently disclosed two-part resin system.

In view of the drawbacks of the prior art, it is an objective of the present disclosure to provide a curable two-part resin system capable of achieving one or more (or all) of the following properties: a strength of greater than 60 MPa, an elongation at break of greater than 0.8%, and a toughness having a K1c value greater than 2.6 MPAm^{0.5} and a G1C value greater than 500 J/m². Furthermore, it is an objective of the present disclosure for the resin system to further achieve beneficial thermal properties, including a Tg greater than 190° C., a coefficient of thermal expansion (CTE) equal to or less than 22 ppm/K, a very low crack temperature index (SCT) less than −200° C., and additionally a good flowability as indicated by a moderate viscosity of less than 10 Pas at 60° C., no toxic label (as defined below) and containing minimal to no nanoparticles, which are complex in production.

### DETAILED DESCRIPTION

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

As used herein, the term “substantially free” refers to a composition or blend in which a particular compound or moiety is present in an amount that has no material effect on the composition or blend. In some embodiments, “substantially free” may refer to a composition or blend in which the particular compound or moiety is present in the composition or blend in an amount of less than 2% by weight, or less than 1% by weight, or less than 0.5% by weight, or less than 0.1% by weight, or less than 0.05% by weight, or even less than 0.01% by weight, based on the total weight of the composition or blend, or that no amount of that particular compound or moiety is present in the respective composition or blend.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the terms “or combinations thereof” and “and combinations thereof” when used with the phrases “selected from” or “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the term “ambient temperature” refers to the temperature of the surrounding work environment (e.g., the temperature of the area, building or room where the curable system is used or produced), exclusive of any temperature changes induced by a chemical reaction. The ambient temperature is typically between about 10° C. and about 30° C., more specifically about 25° C. The term “ambient temperature” is used interchangeably with “room temperature” herein.

The present disclosure is related to a curable two-part resin system, comprising (a) a resin part, comprising at least one cycloaliphatic epoxy resin and (b) a hardener part, comprising (i) at least one alicyclic anhydride, and (ii) a block-copolymer comprising polysiloxane blocks and organic blocks, wherein at least one of the resin part and the hardener part further comprises an inorganic filler in an amount such that the curable two-part resin system comprises greater than 60 wt % of the inorganic filler, and wherein the inorganic filler comprises an amorphous inorganic material and a crystalline inorganic material.

In one embodiment, the amorphous inorganic material is amorphous silica, and the crystalline inorganic material is wollastonite.

In one embodiment, the curable two-part resin system is substantially free of rubber particles.

Advantageously, it was discovered that the resin system according to the present disclosure overcomes the disadvantages of the state of the art by achieving features which solve conflicting objectives (as defined below). Such features include good strength (i.e., greater than 60 MPa), a moderate elongation at break (i.e., greater than 0.8%), and a high toughness (i.e., a K1c value greater than 2.6 MPAm^{0.5} and a G1C value greater than 500 J/m²). Furthermore, beneficial thermal properties can be achieved, including a high glass transition temperature (Tg) (i.e., a Tg greater than 190° C.), a small coefficient of thermal expansion (CTE) (i.e., a CTE less than or equal to 22 ppm/K), a very low crack temperature index (SCT) (i.e., an SCT value less than −200° C.), a good flowability (i.e., a modest viscosity of less than 10 Pas at 60° C.), no toxic label and an avoidance of nanoparticles, which are complex in production.

A “toxic label” is defined as a toxic rating (GHS 06) according to EU directive 1272/2008/EU.

The term DX (with e. g. X=10, 50 or 90, as in D10, D50 or D90 respectively) stands for the point in the size distribution up to and including which X % (e. g. 90% for X=90 in D90) of the total volume of material of a sample is comprised. For example, if the D90 is 39 μm, this means that 90% of the sample has a size of 39 μm or smaller.

It was furthermore surprisingly found that the viscosity of the resin system of the present disclosure could be kept at a moderate level (thus improving the processability) when the block-copolymer is in the hardener part as compared to instances when the block-copolymer is in the resin part instead of the hardener part. “Viscosity at a moderate level” is understood as 4 Pas to 10 Pas, in another embodiment as 6 Pas to 8 Pas or no more than 7 Pas, in each case at 60° C.

The resin system of the present disclosure thus offers a combination of advantageous, conflicting features, which usually cannot be maximized simultaneously (but only at the expense of the other feature/parameter). For example, the presently disclosed resin system is able to achieve good toughness despite having a high Tg; moderate elongation despite having a high Tg; good flowability despite having a high filler load and low CTE; low CTE despite high strength and toughness; and no toxic label for the hardener part, even if with a high filler load.

In one embodiment, the organic blocks in the block-copolymer are polyester blocks, for example based on caprolactone or other lactones, or polycarbonate blocks. Non-limiting examples of suitable block-copolymers include polycaprolactone-polysiloxane block copolymer, polylactic acid-polysiloxane block copolymer and polypropylene carbonate-polysiloxane block copolymer. The polysiloxane blocks are for example polydimethylsiloxane blocks or polymethylethylsiloxane blocks. In one specific embodiment, the block-copolymer is a polycaprolactone-polysiloxane block copolymer such as Genioperl® W35 (Wacker Chemie AG, Munich, Germany).

In one embodiment, the resin part (a) and hardener part (b) of the two-part resin system are present in a stoichiometric ratio ±15 mol % of the resin part to the hardener part.

The “stoichiometric ratio ±15 mol %” is understood as a molar amount between 1.15 equivalents of hardener per resin and 0.85 equivalents of hardener per resin. Each mole of anhydride groups is understood as one equivalent of anhydride hardener and each mole of epoxy groups is understood as one equivalent of epoxy resin. The basis of this definition is also applicable to ±14 mol %, or ±12 mol %, or ±10 mol %, or ±8 mol %, or ±6 mol % as used herein. For example, the “stoichiometric ratio ±14 mol %” is understood as a molar amount between 1.14 equivalents of hardener per resin and 0.86 equivalents of hardener per resin.

In a further embodiment, the ratio of resin (a) to hardener (b) is a stoichiometric ratio ±14 mol %, or ±12 mol %, or ±10 mol %, or ±8 mol %, or ±6 mol %. Preferably, resin (a) and hardener (b) are used in a 1:1 ratio or 6 mol % excess of resin (a) or 8 mol % excess of resin (a) or 12 mol % excess of resin (a).

The cycloaliphatic epoxy resin may, for example, be selected from the group consisting of bis(epoxycyclohexyl)-methylcarboxylate, bis(2,3-epoxycyclopentyl)ether, 1,2-bis(2,3-epoxycyclopentyl)ethane, vinylcyclohexene dioxide, 3,4-epoxycyclohexylmethyl-3′,4′-epoxycyclohexane carboxylate, 3,4-epoxy-6-methylcyclohexylmethyl-3′,4′-epoxy-6′-ethylcyclohexane carboxylate, bis(3,4-epoxycyclohexylmethyl)adipate, bis(3,4-epoxy-6-methylcyclohexylmethyl)adipate, dicyclopentadiene dioxide, dipentene dioxide, 1,2,5,6-diepoxycyclooctane, 1,2,7,8-diepoxyoctane, 1,3-butadiene diepoxide, 3-ethyl-3-oxetanemethanol, and combinations thereof.

In another embodiment, the cycloaliphatic epoxy resin is a non-glycidyl epoxy resin.

In yet another embodiment, the cycloaliphatic epoxy resin is 3,4-epoxycyclohexylmethyl-3′,4′-epoxycyclohexancarboxylate.

In one embodiment, the alicyclic anhydride is an unsaturated compound.

In a preferred embodiment, the alicyclic anhydride comprises 9 to 10 carbons.

The alicyclic anhydride may, for example, be selected from the group consisting of methyltetrahydrophthalic anhydride (MTHPA), himic anhydride, methyl-5-norbornene-2,3-dicarboxylic anhydride (MNA), hexahydro-methylphthalic anhydride, tetrahydrophthalic anhydride, methylphthalic anhydride, naphthalic anhydride, dodecenylsuccinic anhydride and derivatives of succinic anhydride.

In one particular embodiment, the alicyclic anhydride is methyltetrahydrophthalic anhydride (MTHPA), himic anhydride or methyl-5-norbornene-2,3-dicarboxylic anhydride (MNA).

In another embodiment, the curable system is free of an amine hardener, in particular free of a primary amine or secondary amine, a mercaptan hardener and/or a latent curing agent.

In yet another embodiment, the inorganic filler is present in the resin part and/or the hardener part such that the curable two-part resin system comprises 65 wt % to 73 wt % of the inorganic filler based on the total weight of the two-part curable system. According to another embodiment, the curable two-part system comprises 66 wt % to 72 wt %, in particular 67 wt % to 71 wt %, of the inorganic filler. In a specific embodiment, the curable two-part system comprises greater than 61 wt %, or greater than 63 wt %, or greater than 65 wt %, or greater than 67 wt % of the inorganic filler.

In a particular embodiment, the content of amorphous inorganic material in the curable two-part resin system is greater than 24 wt %, in particular greater than 35 wt %. According to another embodiment, the curable system comprises 25 wt % to 35 wt %, in particular 28 wt % to 33 wt %, of the amorphous inorganic material.

In yet another embodiment, the crystalline inorganic material is present in the resin part and/or the hardener part in amount such that the two-part curable system comprises greater than 24 wt %, in particular greater than 29 wt % of the crystalline inorganic material based on the total weight of the two-part curable system. According to another embodiment, the curable two-part system comprises 30 wt % to 50 wt %, in particular 33 wt % to 40 wt %, of the crystalline inorganic material.

In one particular embodiment, the amorphous inorganic material and the crystalline inorganic material are present in the inorganic filler at a weight ratio between 3:7 and 7:3, in particular between 5:7 and 7:7 of the amorphous inorganic material to crystalline inorganic material.

According to one aspect, the crystalline inorganic material is a silicate or an inosilicate. In another aspect, the crystalline inorganic material is an inosilicate with a periodicity of 3. In still yet another aspect, the crystalline inorganic material is Wollastonite (Ca₃Si₃O₉).

In a further aspect, the amorphous inorganic material is natural or synthetic amorphous silica. In another aspect, the amorphous inorganic material is synthetic amorphous silica. In still yet another aspect, the amorphous inorganic material is fused silica.

According to one embodiment, the amorphous inorganic material has an average particle size from 3 μm to 100 μm. In another embodiment, the amorphous inorganic material has an average particle between 7 μm and 50 μm or between 10 μm and 30 μm or between 15 μm and 25 μm.

According to a further embodiment, the crystalline inorganic material has an average particle size from 1 μm to 70 μm. In another embodiment, the crystalline inorganic material has an average particle is between 2 μm and 50 μm or between 3 μm and 30 μm or between 5 μm and 20 μm.

In another embodiment, the block-copolymer with polysiloxane blocks and organic blocks is present in an amount between 1 to 5 wt %, in particular 3 to 5 wt %, based on the total weight of the curable two-part resin system.

In one particular embodiment, the curable two-part system further comprises a core-shell type toughener, in particular in an amount between 1 and 5 wt %, most preferably in an amount between 3 and 5 wt % based on the total weight of the curable two-part system. In a further embodiment, 70 wt % or more, in particular 95 wt % or more, of the core-shell type toughener is comprised in the resin part based on the total weight of the curable two-part system. Adding the core-shell type toughener to the resin part advantageously allows a reduced viscosity of the hardener part and allows thus improved mixing of the resin part and the hardener part.

In yet another embodiment, the core-shell type toughener has a silicone core and/or a poly(methyl methacrylate) shell.

In one embodiment, the cured system comprises one or more additional components in a total amount of less than 20 wt % based on the total weight of the curable two-part system. The additional component or the additional components may, for example, be selected from the group consisting of an anti-settling agent, a coupling agent, a wetting agent, a color agent, an accelerator, a polyol and/or another anhydride other than MTHPA or MNA. In a particular embodiment, the anhydride other than MTHPA or MNA is comprised in the hardener.

The present disclosure is also directed to a cured article obtainable by curing the curable system according to the disclosure above. In one embodiment, the resin part and the hardener part are each homogenized (e. g. stirred) before combining and curing to yield the cured article.

Moreover, the present disclosure is directed to the use of the cured article as disclosed above for electrical applications, in particular for encapsulation of inverters, stators and/or rotors of electrical motors, in particular electrical motors without a permanent magnet.

### EXAMPLES

### Component Description:

ARALDITE® HY 918-1: Methyltetrahydrophthalic Anhydride (MTHPA), Supplier: Huntsman International LLC, The Woodlands, TX.

Amorphous silica 1: fused silica with D10=2 μm, D50=11 μm, D90=39 μm, supplier: Quarzwerke Group, Frechen, Germany.

Amorphous silica 2: fused silica with D10=2.5 μm, D50=20 μm, D90=50 μm, supplier: Quarzwerke Group Frechen, Germany.

Amorphous silica 3: epoxy-silane-surface treated fused silica with D10=3 μm, D50=17 μm, D90=50 μm, supplier: Quarzwerke Group Frechen, Germany.

Aerosil 202: hydrophobic fumed silica, supplier: Evonik Industries AG, Essen, Germany.

Byk W 9010: rheologic additive (wetting agent), supplier: Byk Additives and Instruments, Wesel, Germany.

Antischaum SH: silicone-based defoaming agent, supplier: Wacker Chemie AG, Munich, Germany.

Wollastonite 1: Calcium metasilicate (CaSiO₃) with the following specification: particle size D50 of 9-16 microns (<45 microns 84±5 wt. %, <4 microns 26-36 wt. %, <2 microns<28 wt. %); bulk density 0.88-0.97 g/cm3; brightness, Ry>85%; L/D ratio: 3:1; supplier: Nordkalk Oy Ab, Pargas, Finland.

Genioperl® W35: Block-copolymer with silicone and organic blocks (based on caprolactone), supplier: Wacker Chemie AG, Munich, Germany.

Genioperl® P52: Core-Shell particles with silicone-cores and PMMA-shell, supplier: Wacker Chemie AG, Munich, Germany.

ARALDITE® CY 179-1 (also sold under the name Celloxide 2021 P): 3,4-epoxycyclohexylmethyl-3′,4′-epoxycyclohexanecarboxylate, supplied by Huntsman Advanced Materials (Switzerland) GmbH, Basel, Switzerland

ARALDITE® XB 5992 liquid, low viscous bisphenol-A epoxy resin, epoxide number: 4.9-5.1 eq/kg, supplied by Huntsman International LLC, The Woodlands, TX.

ARALDITE® XB 5993 liquid, pre-accelerated anhydride curing agent, supplied by Huntsman International LLC, The Woodlands, TX.

ARADUR® HY 906 anhydride curing agent, mixture of 1-methyl-5-norbornene-2,3-dicarboxylic anhydride and 5-norbornene-2,3-dicarboxylic anhydride, supplied by Huntsman International LLC, The Woodlands, TX.

Accelerator DY 070: 1-methylimidazole, supplied by Huntsman International LLC, The Woodlands, TX.

INITIATOR 1: N-benzyl quinolinium hexafluoro antimonate, supplied by Huntsman International LLC, The Woodlands, TX.

CO-INITIATOR 1: 1,1,2,2-tetraphenyl-1,2-ethanediol, supplied by Natland International Corporation, Morrisville, NC.

NANOPDX® E 601:60% by weight of 3,4-epoxy cyclohexyl)-methyl-3,4-epoxycyclohexanecarboxylate and 40% by weight of surface-modified silica nanoparticles, supplied by Evonik Industries AG, Essen, Germany.

AEROSIL® R 972: fumed silica after-treated with DDS (dimethyldichlorosilane), supplied by Evonik Industries AG, Essen, Germany.

BYK W 940: anti-settling additive, supplied by Byk Additives and Instruments, Wesel, Germany.

BYK W 995: wetting and dispersing agent, phosphate-containing polyester, supplied by Byk Additives and Instruments, Wesel, Germany.

BYK 070: defoaming agent based on silicones and polymers, supplied by Byk Additives and Instruments, Wesel, Germany.

BAYFERROX® 225: iron oxide pigment, supplied by Lanxess AG, Cologne, Germany.

TREMIN® 283-600: wollastonite, surface-treated with an epoxy silane, average particle size D50: 21 μm, supplied by Quarzwerke Group, Frechen, Germany.

SILAN A-187: γ-glycidyloxypropyltrimethoxysilane, supplied by Momentive Performance Materials, Inc., Waterford, NY.

Bä 3579-3: Pre-mixture of 82 pbw of ARADUR® HY 918-1 and 0.5 pbw of Accelerator DY 070.

### Methods:

Unless otherwise indicated, the viscosity is determined with a Rheomat equipment (type 115, MS DIN 125 D=10/s) at 60° C.

Tensile strength and elongation at break are determined at 23° C. according to ISO R527.

KIC (critical stress intensity factor) in MPa·\sqrt{m} and GIC (specific break energy) in J/m2 are determined at 23° C. by double torsion experiment (Huntsman-internal method).

CTE (coefficient of linear thermal expansion) is determined according to DIN 53752.

Tg (glass transition temperature) is determined according to ISO 6721/94.

SCT: Crack index (simulated crack temperature) is calculated based on Tg, GIC, CTE and elongation at break according to the description given in published PCT application, WO 2000/055254.

### COMPARATIVE AND INVENTIVE EXAMPLES

### Comparative Example 1 (SoA1)

Initially, 2 master batches containing the ingredients of the initiator were prepared as follows:

Masterbatch A: 90 g of ARALDITE® CY 179-1 and 10 g of Co-initiator 1 were mixed at 90° C. for 30 min. The resulting clear solution was cooled to room temperature.

Masterbatch B: 90 g of ARALDITE® CY 179-1 and 10 g of Initiator 1 were mixed at 60° C. for 30 min. The resulting clear solution was cooled to room temperature.

138 g of ARALDITE® CY 179-1, 450 g of NANOPDX® E 601, 34 g of masterbatch A, 26 g of masterbatch B, 4.2 g of SILFOAM® SH, 10 g BYK-W 940, 4.2 g BYK 070 and 4.0 g AEROSIL® R 972 were put into an Esco mixer of sufficient size. The content of the mixer was then stirred with a disperser stirrer with 100 rpm while heating up to 50° C.

Then 435 g of AMOSIL® 510 and 894.6 g of AMOSIL®520 were added slowly in several portions while mixing at 100 rpm. After 5 min the mixer was stopped, and material adhering to the walls was transferred back into the mixture. Then the mixture was stirred for another 70 min. under vacuum at 50° C. After 30 min. of mixing substance adhering to the walls was again put back into the mixture.

To produce 4 mm thick test plates, metal moulds were preheated to about 80° C. in an oven. Then the degassed resin was poured in the mould. The mould was then put to an oven at 120° C. for 1 hour. After that the oven temperature was raised to 180° C. for 90 min. Then the mould was taken out of the oven and opened after cooling down to room temperature. The obtained plate was used to cut out test specimens for the K1C/G1C tests, for the tensile strength testing, the Tg measurement via DSC and the determination of the CTE according to the standards mentioned above. The results are given in Table 2.

### Comparative Example 2 (SoA2)

1. Epoxy Resin Formulation:

950 g NANOPDX® E 601, 3.75 g SI LFOAM® SH, 5.0 g BYK W 995, 6.25 g BYK 070, 12.5 g SI LAN A-187 and 22.5 g AEROSIL® R 972 were put to an Esco mixer of sufficient size. The content of the mixer was then heated up 60° C. and stirred with a dissolver stirrer with 300 rpm under vacuum at 60° C. for 3 min. Then the vacuum was broken and 500 g of AMOSIL® 510 and 1000 g of AMOSIL®520 were added slowly in several portions while mixing at 300 rpm at 60-65° C. under vacuum. After 10 min the mixer was stopped, the vacuum was broken, material adhering to the walls was put back to the mixture. Then the mixture was stirred another 5 min under vacuum at 60-65° C. The vacuum was broken, and the mixer walls were cleared again. Finally, the mixture was stirred for 20 min under vacuum at 300 rpm at 60-65° C.

2. Hardener Formulation:

879.8 g ARADUR® HY 906, 7.4 g ACCELERATOR 1, 10 g SILAN A-187 and 10 g of BYK-W 940 were put to an Esco mixer of sufficient size. The content of the mixer was then heated up 50° C. and stirred with a dissolver stirrer with 300 rpm under vacuum at 50° C. for 3 min. Then the vacuum was broken and 1092.8 g of AMOSIL® 510 were added slowly in several portions while mixing at 300 rpm at 50° C. under vacuum. After 10 min the mixer was stopped, the vacuum was broken, and material adhering to the walls was put back to the mixture. Then the mixture was stirred another 5 min under vacuum at 50-55° C. The vacuum was broken, and the mixer walls were scratched again. Finally, the mixture was stirred for 20 min under vacuum at 300 rpm at 55-60° C.

3. Preparation of Resin/Hardener-Mixture and Curing:

500 g of resin formulation and 325 g of hardener formulation were put together and heated to about 60° C. while stirring with 100 rpm under vacuum.

To produce 4 mm thick test plates, metal moulds were preheated to about 80° C. in an oven. Then the degassed resin/hardener mixture was poured into the mould. The mould was then put to an oven at 100° C. for one hour, then for 1.5 hours at 140° C. and finally for 1.5 hours at 210° C. Then the mould was taken out of the oven and opened after cooling down to room temperature. The cured plate was subjected to various tests the results of which are given in Table 2.

### Comparative Example 3 (SoA3)

This comparative example of the commercial system Araldite® CW 5742/Aradur® HW 30294 was not reproduced. The data given in Table 2 were taken from the technical data sheet made available from Huntsman International LLC or an affiliate thereof.

### Comparative Example 4 (SoA4)

As described in Example 2 of WO 2010/112272, 100 g of ARALDITE® XB 5992 were mixed with 90 g of ARALDITE® XB 5993 and the mixture was heated while slightly stirring with a propeller stirrer to about 60° C. for about 5 minutes. Then the mixer was stopped and 2 g of BAYFERROX® 225 was added and the mixer was started again for about 1 min. Subsequently, while stirring, 51.3 g of TREMIN® 283-600 EST and 290.7 g of AMOSIL®520 were added in portions and the mixture was heated up to 60° C. under stirring for about 10 minutes. Then the mixer was stopped, and the vessel was degassed carefully by applying a vacuum for about 1 minute.

The mixture was poured into a 140° C. hot steel mould to prepare plates for the determination of the properties (4 mm thickness). The mould was then put to an oven for 30 minutes at 140° C. After thermally curing the mould, the mould was taken out of the oven and the plates were cooled down to ambient temperature. The results of the tests are summarized in Table 2.

### Comparative Example 5 (SoA5)

This comparative example was not reproduced. The data in Table 2 were taken from the inventive example in EP 3255103 B1 (given there in “Tabelle 1/Erfindung (2)”)

### Comparative Example 6 (SoA6)

93 g of Araldite® MY 740 resin were mixed with 6 g of Genioperl® W 35 at 90° C. with a blade mixer for 15 min. Then, the mixture was cooled down to 60° C. and 1 g of Silquest® A-187 silane was added and mixed in with a blade mixer for 5 min. Then, 85 g of Ba 3579-3 were added and mixed at 60° C. with a blade agitator for 5 min. Then, 278 g Silbond W12 silica were added in portions while heating up the mixture to about 60° C. within 10 min. Finally, the mixture was degassed under vacuum. The viscosity of the mixture was measured at 60 and 80° C. After degassing, the reaction mass was then poured into a mould (preheated to 100° C.) to prepare plates for the mechanical test. The mould was put to an oven for 2 hours at 100° C. and 16 hours at 140° C.

After cooling and demoulding, the plates were machined into test specimens and subjected to determine the mechanical parameters.

### Inventive Example 1

The inventive component A (i.e., the resin part) was prepared as following:

In a 2l ESCO mixer with exterior heating and speed disc for stirring following components were added: 503.4 g Celloxide 2021 P, 4 g RPS 1312-1, 2.2 g Antischaum SH, 20 g Silan A-187 at room temperature to vessel. All components were heated up to 50° C. while stirring for 20 min at 700 rpm under a vacuum of 10 mbar. Then 100 g Genioperl® P52, 200 g amorphous silica 2, 460 g amorphous silica 3, 670 g Wollastonite 1 and 9 g Bentone SD-2, were added to the mixing vessel under stirring in portions (temperature decreased to 35-40° C.). The mixture was stirred (700 rpm) at 50° C. at 10 mbar for 40 min. Then 4 g BYK W-9010 were added to the mixture. The mixture was stirred again for 30 min at 700 rpm at 10 mbar. Finally, the mixture (component A) was cooled down to 40° C. and discharged into a container.

The inventive component B (i.e., the hardener part) was prepared as follows:

In a 2 liter ESCO mixer with exterior heating and speed disc for stirring, 522.4 g ARADUR® HY 906 was added. Then the vessel was heated up to 75-80° C. 100 g Genioperl® W 35 were then added. At 75-80° C. the mixture was stirred under vacuum (10-15 mbar) until the Genioperl® W 35 was totally dissolved in the ARADUR® HY 906 (very slightly opaque liquid). Afterwards it was cooled to 50-55° C. and 0.6 g Oracet blue 690 was added. Then the mixture was stirred until a homogenous blue liquid was visible. Then 2.4 g DY 070, 10 g BYK W 980, 6.6 g BYK W 9010 and 1 g PEG 200 were added at 50-55° C. into the vessel. Then the mixture was stirred with 300 rpm under vacuum (10 mbar) for 20 min at 55° C. Then 520 g Amorphous silica 2, 820 g Wollastonite 1 and 10 g Bentone SD-2 were added in portions to the liquid while stirring and increasing the stirrer speed to 700 rpm under vacuum (10 mbar). The temperature should rise within 20 min to 55-60° C. due to the stirring. The mixture was kept under stirring for 20 min at 700 rpm and vacuum (10 mbar) without heating (temperature in the vessel was 55-60° C.). Then 7 g Aerosil R-202 was added to the mixture and stirred in at 700 rpm for 10 min at 55-60° C. Then the speed was increased to 800 rpm for another 10 min. Finally, the mixture was cooled to 40-45° C. and discharged into a container.

Preparation of Final Mixture of Component A and B:

300 g of the resin formulation (component A) and 405 g of the hardener formulation (component B) were put together and heated to about 60° C. while stirring with 100 rpm under vacuum.

To produce 4 mm thick test plates, metal moulds were preheated to about 120° C. in an oven. Then the degassed resin/hardener mixture was poured into the mould. The mould was then put to an oven at 120° C. for 20 minutes, then heated up to 190° C. and kept at 190° C. for 3 hours. Then the mould was taken out of the oven and opened after cooling down to room temperature. The cured plate was subjected to various tests the results of which are given in Table 2.

### Inventive Example 2

The inventive component A was the same as the one used for inventive example 1. The inventive component B was prepared as following:

In a 2 liter ESCO mixer with exterior heating and speed disc for stirring, 518.4 g ARADURE® HY 918-1 was added. Then it was heated up to 75-80° C. 60 g Genioperl® W 35 was then added. At 75-80° C. the mixture was stirred under vacuum (10-15 mbar) until the Genioperl® W 35 was totally dissolved in the ARADURE® HY 918. Afterwards it was cooled to 50-55° C. and 0.6 g Oracet blue 690, 3 g DY 070, 10 g BYK W 980, 7 g BYK W 9010 were added at 50-55° C. into the vessel. Then the mixture was stirred with 300 rpm under vacuum (10 mbar) for 20 min at 55° C. Then 564 g Amorphous silica 2, 820 g Wollastonite 1 and 10 g Bentone SD-2 were added in portions to the liquid while stirring and increasing the stirrer speed to 700 rpm under vacuum (10 mbar). The temperature should rise within 20 min. to 55-60° C. due to the stirring. The mixture was kept under stirring for 20 min at 700 rpm and vacuum (10 mbar) without heating (temperature in the vessel 55-60° C.). Then 7 g Aerosil R-202 was added to the mixture and stirred in at 700 rpm for 10 min at 55-60° C. Then the speed was increased to 800 rpm for another 10 min. Finally, the mixture was cooled to 40-45° C. and discharged into a container.

Preparation of Final Mixture of A and B:

300 g of the resin formulation (component A) and 375 g of the hardener formulation (component B) were put together and heated to about 60° C. while stirring with 100 rpm under vacuum.

To produce 4 mm thick test plates, metal moulds were preheated to about 120° C. in an oven. Then the degassed resin/hardener mixture was poured into the mould. The mould was then put to an oven at 120° C. for 20 minutes, then heated up to 190° C. and kept at 190° C. for 3 hours. Then the mould was taken out of the oven and opened after cooling down to room temperature. The cured plate was subjected to various tests the results of which are given in Table 2.

### Comparative Example 7

The comparative component A (i.e., the resin part) was prepared as following: In a 2 L ESCO mixer with exterior heating and speed disc for stirring, 503.4 g Celloxide 2021 P was added. This was heated up to 80° C. and then 100 g Genioperl W35 was added this was stirred for 1 hour until the W35 was completely dissolved in the resin. After cooling the mass to 60° C., 4 g RPS 1312-1, 2.2 g Antischaum SH, 20 g Silan A-187 were added to the vessel. All components were stirred for 20 min at 700 rpm under a vacuum of 10 mbar. Then 200 g amorphous silica 2, 460 g amorphous silica 3, 670 g Wollastonite 1, 9 g Bentone SD-2, are added to the mixing vessel under stirring in portions (temp. decreased to 35-40° C.). The mixture is stirred (700 rpm) at 50° C. at 10 mbar for 40 min. Then 4 g BYK W-9010 are added to the mixture. The mixture is stirred again for 30 min at 700 rpm at 10 mbar. Finally, the mixture (component A) is cooled down to 40° C. and discharged into a container.

The comparative component B (i.e., the hardener part) is prepared as following:

In a 2 liter ESCO mixer with exterior heating and speed disc for stirring following components are added: 522.4 g ARADURE® HY 906. Then it was heated up to 75-80° C. 100 g Genioperl® W 35 were added. At 75-80° C. the mixture was stirred under vacuum (10-15 mbar) until the Genioperl W 35 was totally dissolved in ARADURE® HY 906 (very slightly opaque liquid). Afterwards it was cooled to 50-55° C. and 0.6 g Oracet blue 690 was added. Then the mixture was stirred until a homogenous blue liquid is visible. Then 2.4 g DY 070, 10 g BYK W 980, 6.6 g BYK W 9010 and 1 g PEG 200 were added at 50-55° C. into the vessel.

Then the mixture was stirred with 300 rpm under vacuum (10 mbar) for 20 min at 55° C. Then 520 g Amorphous silica 2, 820 g Wollastonite 1 and 10 g Bentone SD-2 were added in portions to the liquid while stirring and increasing the stirrer speed to 700 rpm under vacuum (10 mbar). The temperature should rise within 20 min to 55-60° C. due to the stirring.

The mixture was kept under stirring for 20 min at 700 rpm and vacuum (10 mbar) without heating (temperature in the vessel 55-60° C.). Then 7 g Aerosil R-202 was added to the mixture and stirred in at 700 rpm for 10 min at 55-60° C. Then the speed was increased to 800 rpm for another 10 min. Finally, the mixture was cooled to 40-45° C. and discharged into a container.

Preparation of Final Mixture of A and B:

300 g of resin formulation (component A) and 405 g of hardener formulation (component B) were put together and heated to about 60° C. while stirring with 100 rpm under vacuum.

To produce 4 mm thick test plates, metal moulds were preheated to about 120° C. in an oven. Then the degassed resin/hardener mixture was poured into the mould. The mould was then put to an oven at 120° C. for 20 minutes, then heated up to 190° C. and kept at 190° C. for 3 hours. Then the mould was taken out of the oven and opened after cooling down to room temperature. The cured plate was subjected to various tests the results of which are given in Table 2.

### Evaluation

TABLE 1
Comparison of the components of the SoA with the components of the inventive systems.

| | | | Filler | | | Ratio | | |
|---|---|---|---|---|---|---|---|---|
| | | | load | | fused | wollastonite | SBM | Core-Shell |
| | Resin | | total | Wollastonite | silica | to silica | (W35) | (P52) |
| | type | Hardener | wt % | wt % | wt % | wt % | wt % | wt % |
| Target | | | 60-76 | >25 | >25 | 3:7-7:3 | 1-5 | 1-5 |
| SoA 1 | CY 179 | Initiator 1 + | 75.68 | 0.00 | 66.50 | 0.00% | 0.00 | 0.00 |
| | | Co-Initiator | | | | | | |
| | | 1 | | | | | | |
| SoA 2 | CY 179 | MNA | 67.1 | 0.0 | 57.9 | 0.00 | 0.0 | 0.0 |
| SoA 3 | CY 179 | MTHPA | 73.68 | 19 | 0 | | 0.0 | 0.0 |
| SoA 4 | BADGE- | MTHPA- | 64.37 | 9.6 | 54.4 | 17.65 | 0.0 | 0.0 |
| | based | based | | | | | | |
| SoA 5 | BADGE- | MTHPA- | 66.00 | 0 | 0 | | 1 | 0 |
| | based | based | | | | | | |
| SoA 6 | BADGE- | MTHPA- | 60.00 | 0 | 0 | | 1 | 0 |
| | based | based | | | | | | |
| Inventive 1 | CY 179 | MNA | 67.50 | 37.8 | 29.0 | 130.34 | 2.87 | 2.13 |
| Inventive 2 | CY 179 | MTHPA | 70.00 | 37.7 | 30.3 | 124.19 | 1.70 | 2.22 |
| Compara- | CY 179 | MNA | 67.50 | 37.8 | 29.0 | 130.34 | 5.00 | 0.00 |
| tive 7 | | | | | | | | |

TABLE 2
Comparison of the performance of the SoA with the performance of the inventive systems.

| | viscosity | | | elongation | | toughness | | | |
|---|---|---|---|---|---|---|---|---|---|
| | at 60° C. | CTE/ | strength | at break | toughness | [G1C/ | | | Application |
| | [Pas] | ppm/K | [MPa] | [%] | [K1C] | J/m²] | TG [° C.] | SCT | stability |
| Target | <10 | ≤22 | ≥60 | >0.8 | >2.6 | >500 | >190° C. | <200 | OK |
| SoA 1 | 15 | 20 | 75 | 0.6 | 2.4 | 320 | 184 | −271 | OK |
| SoA 2 | 5 | 24 | | 0.65 | 2.2 | 362 | 205 | −184 | OK |
| SoA 3 | 2 | 27 | 57 | 0.4 | 2.4 | 320 | 192 | −13 | OK |
| SoA 4 | 9 | 26 | 86 | 1.1 | 2.4 | 441 | 105 | −131 | OK |
| SoA 5 | | | | | | 840 | 110 | | OK |
| SoA 6 | 3 | >30 | 78 | 1.4 | 2.8 | 831 | 139 | −58 | |
| Inventive 1 | 7 | 22 | 68 | 1.3 | 2.8 | 770 | 226 | −244 | OK |
| Inventive 2 | 7 | 20.66 | 72 | 1.2 | 2.9 | 641 | 200 | −308 | OK |
| Compara- | 7 | | | | | | 220 | | NO |
| tive 7 | | | | | | | | | K |

“Application stability” means no viscosity increase during 1 week mixing at 60° C., no impact on Tg.

The comparison of the Inventive example 1 with the 6 different SoA (state of the art) examples shows that the invention meets all nine of the features set forth below, while the state of the art is incapable of meeting all of the features:
1) Avoidance of products which are complex in production, in particular because of the use of nanoparticles
2) A good flowability (indicated by a viscosity of less than 10 Pas at 60° C.)
3) A very low coefficient of thermal expansion (CTE) of at most 22 ppm/K
4) A high strength of more than 60 MPa
5) A high elongation at break of greater than 0.8%
6) A high toughness (K1C>2.6 MPam^{0.5} and a G1C of >500 J/m2)
7) A high Tg of at least 190° C.
8) A very low resulting SCT of at most −200° C.
9) A good stability of the resin hardener (application stability)

SoA1 is an example for a system with a relatively low CTE and a high Tg based on homopolymerisation of an epoxy resin. This concept is lacking meeting requirements 1, 2, 5, 6 of the conflicting features. Furthermore, the system of SoA1 shows a lower Tg than the Inventive example 1.

SoA2 contains nano-SiO 2 but it contains neither wollastonite, nor core-shell nor block-compoymer-type components. Most of the mechanical parameters are significantly worse than the Inventive example 1.

SoA3 is another known example of a high-Tg system. While this contains wollastonite, it does not contain fused silica, nor core-shell nor block-copolymer-type components. The system is mechanically poor and does not meet criteria 3, 4, 5, or 7 of the conflicting features.

SoA4 is an example of combining wollastonite and fused silica. However, the system shows a poor performance because it is not based on the inventive selection of resin components, has the wrong ratio of fused silica and wollastonite and does not contain core-shell or block-copolymer-type components.

SoA5 is a published example of a system containing a block-copolymer component but lacks wollastonite or fused silica. The system is far away from meeting the overall profile, in particular because of the low Tg.

SoA6 contains a block-copolymer component like SoA5, but again lacks wollastonite or fused silica. The system's performance is worse than the inventive system in numerous aspects.

Comparative example 7 demonstrates that a potential use of a polysilicone-polycaprolactone-block-copolymer component in the resin part of the formulation is not viable. While the performance meets the target, the problem is the stability of the resin part during the application process: Such resin tends to increase the viscosity during being mixed over one week at 60° C. and is hence not applicable.

Inventive example 2 is just another example in line with the inventive side conditions and shows that also with other types of anhydrides the target property profile can be met if the inventive requirements are met.

1. A curable two-part resin system, comprising
(a) a resin part, comprising at least one cycloaliphatic epoxy resin and
(b) a hardener part, comprising (i) at least one alicyclic anhydride, and (ii) a block-copolymer comprising polysiloxane blocks and organic blocks,
wherein at least one of the resin part and the hardener part further comprises an inorganic filler in an amount such that the curable system comprises greater than 60 wt % of the inorganic filler, and wherein the inorganic filler comprises an amorphous inorganic material and a crystalline inorganic material.

2. The curable system according to claim 1, wherein the resin part (a) and the hardener part (b) in the curable system is a stoichiometric ratio ±15 mol %.

3. The curable system according to claim 1, wherein the cycloaliphatic epoxy resin is a non-glycidyl epoxy resin.

4. The curable system according to claim 3, wherein the cycloaliphatic epoxy resin is 3,4-epoxycyclohexylmethyl-3′,4′-epoxycyclohexancarboxylat.

5. The curable system according to claim 1, wherein the alicyclic anhydride is an unsaturated compound.

6. The curable system according to claim 1, wherein the alicyclic anhydride comprises 9 to 10 carbons.

7. The curable system according to claim 1, wherein the alicyclic anhydride is methyltetrahydrophthalic anhydride (MTHPA), himic anhydride or methyl-5-norbornene-2,3-dicarboxylic anhydride (MNA).

8. The curable system according to claim 1, wherein the curable system is free of an amine hardener, a mercaptan hardener and/or a latent curing agent.

9. The curable system according to claim 1, wherein the inorganic filler is present in the resin part and/or the hardener part such that the curable system comprises 65 wt % to 73 wt % of the inorganic filler based on the total weight of the curable system.

10. The curable system according to claim 1, wherein the content of amorphous inorganic material in the curable system is greater than 24 wt %, based on the total weight of the curable system.

11. The curable system according to claim 1, wherein the content of crystalline inorganic material in the curable system is greater than 24 wt % based on the total weight of the curable system.

12. The curable system according to claim 1, wherein the amorphous inorganic material and the crystalline inorganic material are present in the inorganic filler at a weight ratio between 3:7 and 7:3 of the amorphous inorganic material to crystalline inorganic material.

13. The curable system according to claim 1, further comprising a core-shell type toughener.

14. The curable system according to claim 1, wherein the organic blocks in the block-copolymer are polyester blocks.

15. The curable system according to claim 1, wherein the block-copolymer is present in an amount between between 1 to 5 wt % based on the total weight of the curable two-part resin system

16. A cured article obtainable by curing the curable system according to claim 1.

17. (canceled)
